(19) United States
(12) Patent Application Publication
(10) Pub. No.: US 2021/0342201 A1
(43) Pub. Date: Nov. 4, 2021

(54) INFORMATION PROCESSING APPARATUS, INFORMATION PROCESSING METHOD, INFORMATION PROVIDING APPARATUS, INFORMATION PROVIDING METHOD, PRESENTATION CONTROLLING APPARATUS, PRESENTATION CONTROLLING METHOD, AND INFORMATION PROCESSING SYSTEM

(71) Applicant: SONY SEMICONDUCTOR SOLUTIONS CORPORATION, Kanagawa (JP)

(72) Inventor: Yoshinori OOTA, Kanagawa (JP)

(73) Assignee: SONY SEMICONDUCTOR SOLUTIONS CORPORATION, Kanagawa (JP)

(21) Appl. No.: 17/282,407

(22) PCT Filed: Oct. 3, 2019
(86) PCT No.: PCT/JP2019/039137

§ 371 Date: Apr. 2, 2021

(30) Foreign Application Priority Data
Oct. 11, 2018 (JP) 2018-192448

(51) Int. Cl. G06F 9/50; G06N 3/04

(52) U.S. Cl. CPC G06F 9/5094; G06N 3/04; G06F 9/5016

(57) ABSTRACT

An information processing apparatus is provided which includes a device information provision section configured to provide information related to computing power of a device, and an application acquisition section configured to acquire an application, on the basis that the information related to the computing power satisfies a condition related to computing power necessary for execution of the application.

### TECHNICAL FIELD

The present disclosure relates to an information processing apparatus, an information processing method, an information providing apparatus, an information providing method, a presentation controlling apparatus, a presentation controlling method, and an information processing system.

### BACKGROUND ART

In recent years, a technology for narrowing down (filtering) applications to be downloaded from an information providing apparatus to an information processing apparatus to applications suitable for execution on the information processing apparatus is known.

For example, a technology of narrowing down applications to be downloaded from a server to a smartphone to applications suitable for execution on the smartphone is disclosed (for example, refer to NPL 1). According to such a technology, narrowing down (filtering) is performed on the basis of the size of a display provided on the smartphone, the version of an OS (Operating System) equipped in the smartphone and so forth.

### CITATION LIST

### Non Patent Literature

### [NPL 1]

“Application Manifest,” [online], Apr. 25, 2018, Patent Society, [searched on Oct. 2, 2018], Internet <URL: https://developer.android.com/guide/topics/manifest/manifest-intro?h1=ja>

### SUMMARY

### Technical Problem

However, it is demanded that a technology that makes it possible for an application more suitable for execution on an information processing apparatus to be downloaded to the information processing apparatus.

### Solution to Problem

According to the present disclosure, there is provided an information processing apparatus including a device information provision section configured to provide information related to computing power of a device, and an application acquisition section configured to acquire an application on the basis that the information related to the computing power satisfies a condition related to computing power necessary for execution of the application.

Further, according to the present disclosure, there is provided an information processing method including providing, by a processor, information related to computing power of a device, and acquiring, by the processor, an application on the basis that the information related to the computing power satisfies a condition related to computing power necessary for execution of the application.

Further, according to the present disclosure, there is provided an information providing apparatus including a decision section configured to decide whether or not information related to computing power of a device satisfies a condition related to computing power necessary for execution of an application, and a provision section configured to provide the application on the basis that the information related to the computing power of the device satisfies the condition related to the computing power necessary for execution of the application.

Further, according to the present disclosure, there is provided an information providing method including deciding, by a processor, whether or not information related to computing power of a device satisfies a condition related to computing power necessary for execution of an application, and providing, by the processor, the application on the basis that the information related to the computing power of the device satisfies the condition related to the computing power necessary for execution of the application.

Further, according to the present disclosure, there is provided a presentation controlling apparatus including a decision section configured to decide whether or not information related to computing power of a device satisfies a condition related to computing power necessary for execution of an application, and a presentation controlling section configured to control presentation of a predetermined alert on the basis that the information related to the computing power of the device does not satisfy the condition related to the computing power necessary for execution of the application.

Further, according to the present disclosure, there is provided an presentation controlling method including deciding, by a processor, whether or not information related to computing power of a device satisfies a condition related to computing power necessary for execution of an application, and controlling, by the processor, presentation of a predetermined alert on the basis that the information related to the computing power of the device does not satisfy the condition related to the computing power necessary for execution of the application.

Further, according to the present disclosure, there is provided an information processing system including an information processing apparatus and an information providing apparatus. The information processing apparatus includes a device information provision section configured to provide information related to computing power of a device to the information providing apparatus, and an application acquisition section configured to acquire an application, from the information providing apparatus, on the basis that the information related to the computing power satisfies a condition related to computing power necessary for execution of the application. The information providing apparatus includes a decision section configured to decide whether or not the information related to the computing power of the device satisfies the condition related to the computing power necessary for execution of the application, and a provision section configured to provide the application to the information processing apparatus on the basis that the information related to the computing power of the device satisfies the condition related to the computing power necessary for execution of the application.

### BRIEF DESCRIPTION OF DRAWINGS

FIG. 1 is a view depicting an example of a configuration of an information processing system according to an embodiment of the present disclosure.

FIG. 2 is a view depicting an example of a functional configuration of an application generation apparatus according to the embodiment.

FIG. 3 is a view depicting an example of a functional configuration of a server apparatus according to the embodiment.

FIG. 4 is a view depicting an example of a functional configuration of an application execution apparatus according to the embodiment.

FIG. 5 is a view depicting an example of information provided from the application generation apparatus to the server apparatus.

FIG. 6 is a view depicting an example of device information provided from the application execution apparatus to the server apparatus.

FIG. 7 is a flow chart depicting an example of operation upon application registration of the information processing system according to the embodiment.

FIG. 8 is a flow chart depicting an example of operation upon application execution of the information processing system according to the embodiment.

FIG. 9 is a view depicting an example of a condition necessary for recognition.

FIG. 10 is a view depicting an example of an application selection screen image.

FIG. 11 is a block diagram depicting an example of a hardware configuration of a computer.

### DESCRIPTION OF EMBODIMENT

In the following, a preferred embodiment of the present disclosure is described in detail with reference to the accompanying drawings. It is to be noted that, in the present specification and the drawings, components having substantially same functional configurations are denoted by like reference signs and overlapping description of them is omitted.

Further, in the present specification and the drawings, plural components having substantially same or similar functional configurations are sometimes distinguished from each other with different numerals applied to same reference signs. However, in a case where there is no necessity to specifically distinguish plural components having substantially same or similar functional configurations from each other, only the same reference sign is applied. Further, similar components in different embodiments are sometimes distinguished from each other with different alphabetical characters applied to a same reference sign. However, in a case where there is no necessity to specifically distinguish similar components from each other, only the same reference sign is applied.

It is to be noted that the description is given in the following order.

0. Overview

1. Details of Embodiment
1.1. Example of System Configuration
1.2. Example of Functional Configuration of Application Generation Apparatus
1.3. Example of Functional Configuration of Server

Apparatus
1.4. Example of Functional Configuration of Application Execution Apparatus
1.5. Examples of Various Kinds of Information
1.6. Operation of Information Processing System

2. Example of Hardware Configuration

3. Conclusion

### 0. OVERVIEW

First, an overview of an embodiment of the present disclosure is described. In recent years, a technology for narrowing down (filtering) applications to be downloaded from an information providing apparatus to an information processing apparatus to applications suitable for execution on the information processing apparatus is known.

For example, a technology of narrowing down applications to be downloaded from a server to a smartphone to applications suitable for execution on the smartphone is disclosed. According to such a technology, narrowing down (filtering) is performed on the basis of the size of a display provided on the smartphone, the version of an OS (Operating System) equipped in the smartphone and so forth.

In the description of the embodiment of the present disclosure, a technology that makes it possible for an application more suitable for execution on an information processing apparatus to be downloaded to the information processing apparatus. More particularly, it is supposed that the application suitable for execution by an information processing apparatus can change depending upon how much the computing power of the information processing apparatus has. For example, the lower the computing power of the information processing apparatus, the higher the possibility that the computing power necessary to execute an application may not be obtained and the more likely the application suitable for execution by the information processing apparatus are restricted.

For example, a case is supposed in which information related to the computing power includes the number of cycles per unit time that is capable of being taken for execution of an application. The number of cycles per unit time that is capable of being taken for execution of an application may be a value obtained by subtracting the number of cycles per unit time necessary for execution of a program (OS or the like) other than the application from the number of cycles per unit time of the information processing apparatus. In such a case as just described, if the number of cycles per unit time that is capable of being taken for execution of the application is insufficient, there is the possibility that the application may not be executed normally.

Also, a case is supposed in which information related to the computing power includes a memory size that is capable of being taken for execution of an application. The memory size that is capable of being taken for execution of an application may be a size obtained by subtracting a memory size necessary for exertion of a program (OS or the like) other than the application from a memory size of the information processing apparatus. In such a case as just described, if the memory size that is capable of being taken for execution of the application is insufficient, then there is the possibility that the application may not be executed normally.

Therefore, in the description of the embodiment of the present disclosure, a technology is described which makes it possible for an application according to the computing power of an information processing apparatus to be downloaded to the information processing apparatus.

It is to be noted that the type of an application capable of being applied to the embodiment of the present disclosure is not restrictive. However, in a case where an application is executed without being aware of an OS, middleware or the like, whether the application is suitable for execution by an information processing apparatus can be dependent more strongly upon the computing power of the information processing apparatus. As an example of the application that is executed without being aware of an OS, middleware or the like, an application that uses a neural network or a like application is supposed.

Accordingly, in the following description, principally a case is supposed in which an application that uses a neural network is used as a more preferred embodiment. Further, in addition to an application that uses a neural network, other applications that are executed without being aware of an OS, middleware or the like are also preferable for the embodiment of the present disclosure.

In the following description, an information processing apparatus is also referred to as an “application execution apparatus.” Further, in the following description, an information providing apparatus is also referred to as a “server apparatus.” Furthermore, in the following description, an application that uses a neural network is also referred to as a “neural network application.”

An outline of the embodiment of the present disclosure has been described.

### 1. DETAILS OF EMBODIMENT

Now, details of the embodiment of the present disclosure are described.

### [1.1. Example of System Configuration]

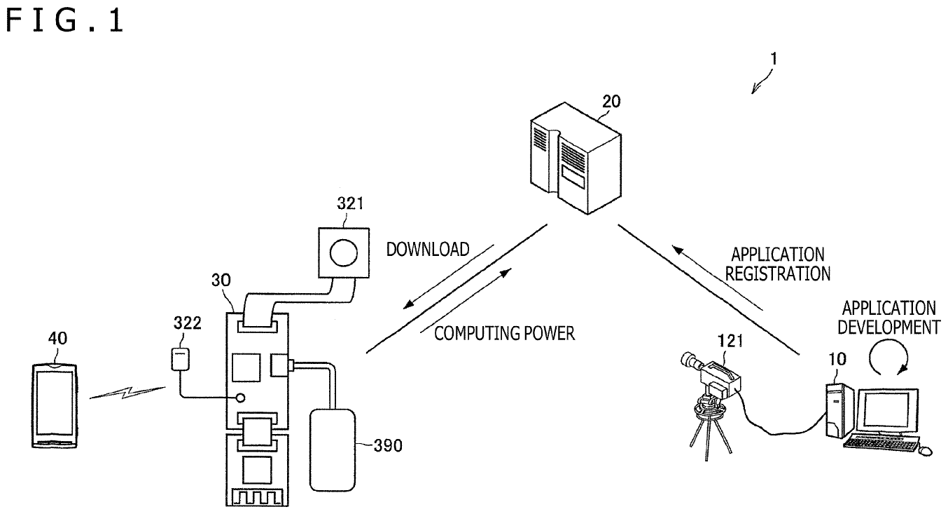

First, an example of a configuration of an information processing system according to the embodiment of the present disclosure is described with reference to the drawings. FIG. 1 is a view depicting an example of a configuration of the information processing system according to the embodiment of the present disclosure. As depicted in FIG. 1, an information processing system 1 according to the embodiment of the present disclosure includes an application generation apparatus 10, a server apparatus 20, an application execution apparatus 30, and a terminal apparatus 40.

The application generation apparatus 10, the server apparatus 20, and the application execution apparatus 30 are connected to a network and can communicate with each other through the network. It is to be noted that, in the example depicted in FIG. 1, one application generation apparatus 10 and one application execution apparatus 30 exist which can communicate with the server apparatus 20 through the network. However, at least a plurality of application generation apparatus 10 or a plurality of application execution apparatus 30 may exist such that they can communicate with the server apparatus 20 through the network.

The application execution apparatus 30 and the terminal apparatus 40 can communicate with each other. For example, the application execution apparatus 30 and the terminal apparatus 40 may be capable of communicating with each other by wireless communication (for example, by short-range wireless communication or the like). However, the application execution apparatus 30 and the terminal apparatus 40 may be capable of communicating with each other by wired communication. Alternatively, in a case where the terminal apparatus 40 is also connected to the network, the application execution apparatus 30 and the terminal apparatus 40 may be capable of communicating with each other through the network.

The application generation apparatus 10 includes, for example, a computer (for example, a workstation or the like). The application generation apparatus 10 is used by a developer of an application and generates an application on the basis of an operation thereof by the application developer (or automatically). For example, the application generation apparatus 10 is connected to a device necessary for learning and generates (constructs) an application (learned neural network application) by performing learning on the basis of data obtained from the device necessary for learning.

FIG. 1 depicts an example in which the application generation apparatus 10 is connected to a camera 121 as an example of the device necessary for learning and performs learning on the basis of image data obtained from the camera 121. In such an example as just described, recognition of an imaging target included in the image data is performed by execution of an application generated by the application generation apparatus 10 (learned neural network application). However, the device necessary for learning is not limited to the camera 121.

For example, the device necessary for learning may be a microphone (hereinafter referred to merely as a “mike”). At this time, it is sufficient if the application generation apparatus 10 performs learning on the basis of sound data obtained from the mike. In such a case as just described, recognition of an utterer of voice data included in the sound data is performed by execution of an application generated by the application generation apparatus 10 (learned neural network application). Alternatively, the device necessary for learning may be a sensor different from the camera and the mike.

In such a manner, in the embodiment of the present disclosure, a case is supposed in which a process for recognizing some target (for example, an imaging target included in the image data, an utterer of voice data included in the sound data or the like) is performed by execution of an application. However, the process to be performed by execution of the application is not restrictive. In other words, the term “recognition” utilized in the following description may be suitably replaced by a term of “execution of the application.”

After the application generation apparatus 10 generates an application (learned neural network application), it registers the generated application into the server apparatus 20 through the network. At this time, the application generation apparatus 10 registers feature data of the generated application (including the application) into the server apparatus 20 through the network. The feature data of the application is hereinafter described in detail.

The server apparatus 20 includes, for example, a computer. The server apparatus 20 accepts registration of the feature data of the application (including the application) from the application generation apparatus 10. The server apparatus 20 stores the feature data of the application whose registration is accepted.

Further, the server apparatus 20 provides an application according to computing power to the application execution apparatus 30. More particularly, if the server apparatus 20 accepts information related to the computing power of the application execution apparatus 30 from the application execution apparatus 30, then it decides whether or not the information related to the computing power of the application execution apparatus 30 satisfies a condition related to the computing power according to the application. In a case where the information related to the computing power of the application execution apparatus 30 satisfies the condition related to the computing power according to the application, the server apparatus 20 provides the application to the application execution apparatus 30. This makes it possible for the application more suitable for execution by the application execution apparatus 30 to be downloaded to the application execution apparatus 30.

The application execution apparatus 30 includes, for example, a computer. The application execution apparatus 30 is used by a user and establishes connection to the server apparatus 20 on the basis of an operation by the user (for example, an operation for placing an operation mode into an update mode) (or automatically) to provide information related to the computing power of the application execution apparatus 30 itself to the server apparatus 20. After the application according to the computing power of the application execution apparatus 30 itself is downloaded from the server apparatus 20, the application execution apparatus 30 executes the downloaded application. More particularly, on the basis that the information related to the computing power of the application execution apparatus 30 itself satisfies the condition related to the computing power according to the application, the application execution apparatus 30 downloads the application from the server apparatus 20 and executes the application.

The application execution apparatus 30 has a device that can be utilized for recognition (device that can be utilized for execution of the application. The device that can be utilized for recognition detects various kinds of data that are utilized for recognition. Here, although the type of the equipped device is not restrictive, the equipped device may include a camera, may include a mike, or may include a sensor different from the camera and the mike. In the following, the device that can be utilized for recognition is merely referred to as an “equipped device.”

In the example depicted in FIG. 1, the application execution apparatus 30 includes a camera 321 as an example of the equipped device. At this time, the application execution apparatus 30 recognizes an imaging target included in image data obtained by the camera 321 through execution of the application. Further, the application execution apparatus 30 has a mike 322 as an example of the equipped device. At this time, the application execution apparatus 30 recognizes an utterer of voice data included in sound data obtained by the mike 322 through execution of the application.

Further, the application execution apparatus 30 includes a battery 390 for supplying power necessary for causing the application execution apparatus 30 to operate. Further, the application execution apparatus 30 can use the terminal apparatus 40 in order to further narrow down applications to be downloaded. Although the terminal apparatus 40 may typically be a smartphone, it may otherwise be a tablet terminal or a portable telephone set, or otherwise may be a PC (Personal Computer) or other electronic equipment. In the following description, the application execution apparatus 30 is sometimes referred to as a “recognition device.”

An example of a configuration of the information processing system 1 according to the embodiment of the present disclosure has been described.

### [1.2. Example of Functional Configuration of Application Generation Apparatus]

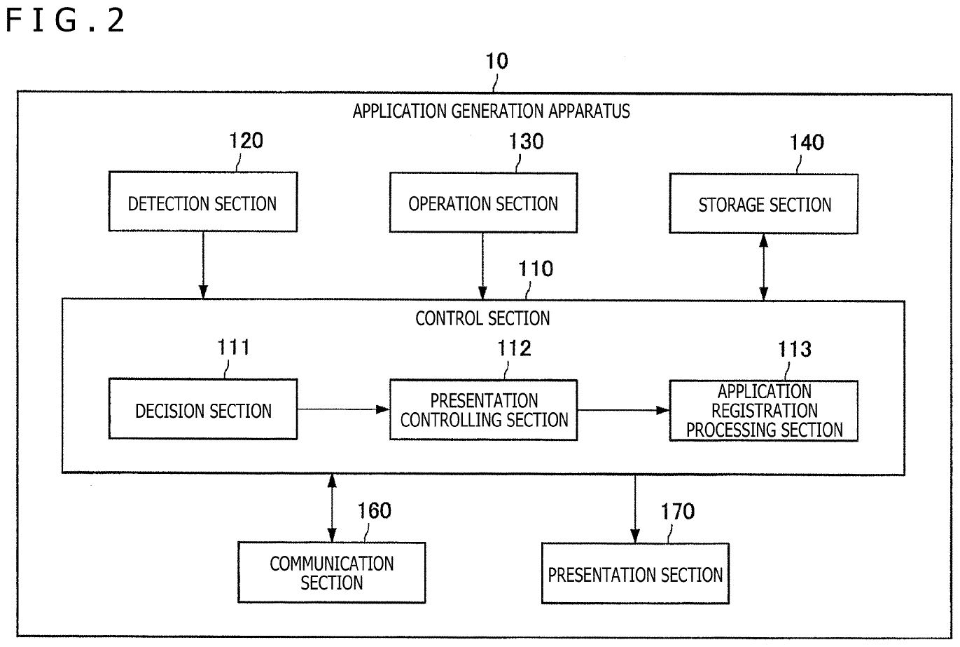

Now, an example of a functional configuration of the application generation apparatus 10 according to the embodiment of the present disclosure. FIG. 2 is a view depicting an example of a functional configuration of the application generation apparatus 10 according to the embodiment of the present disclosure. As depicted in FIG. 2, the application generation apparatus 10 includes a control section 110, a detection section 120, an operation section 130, a storage section 140, a communication section 160, and a presentation section 170.

The control section 110 executes control of the components of the application generation apparatus 10. The control section 110 may include, for example, one or a plurality of CPUs (Central Processing Units: central processing units) and so forth. In a case where the control section 110 includes processing units such as a CPU, such processing units may include electronic circuitry. The control section 110 can be implemented by a program executed by such a processing unit as just described. The control section 110 includes a decision section 111, a presentation controlling section 112, and an application registration processing section 113. Details of the blocks are hereinafter described.

The detection section 120 includes a device necessary for learning. Data necessary for learning is detected by the device necessary for learning. As described hereinabove, the device necessary for learning is not restricted to a specific device. For example, the device necessary for learning may include a camera, may include a mike, or may include a sensor different from the camera and the mike. The data necessary for learning detected by the detection section 120 is provided to the control section 110 and is used for generation (construction) of an application (learned neural network application).

The operation section 130 has a function of accepting an input of an operation by a developer. In the embodiment of the present disclosure, principally a case in which the operation section 130 includes a mouse and a keyboard is assumed. However, the operation section 130 is not limited to the case in which it includes a mouse and a keyboard. For example, the operation section 130 may include a touch panel, may include a touch pad, may include a switch, may include a lever, and may include a button. Further, the operation section 130 may include a mike that detects voice of a developer and may include an image sensor that detects a gaze of the developer.

The storage section 140 includes a memory and is a recording medium that stores a program to be executed by the control section 110 and stores data necessary for execution of the program. Further, the storage section 140 temporarily stores data for arithmetic operation by the control section 110. The storage section 140 includes a magnetic storage section device, a semiconductor storage device, an optical storage device, a magneto-optical storage device or the like.

The communication section 160 includes a communication circuit and has a function for receiving data from the server apparatus 20 connected to the network through the network. Further, the communication section 160 has a function for transmitting data to the server apparatus 20 through the network.

The presentation section 170 has a function for presenting information to the developer. The type of the presentation section 170 is not restrictive. For example, the presentation section 170 may include a display capable of performing viewable display to the developer, and the display may be a liquid crystal display, may be an organic EL (Electro-Luminescence) display, or may be some other display. Alternatively, the presentation section 170 may include a tactile presentation device that presents a sense of touch to the developer or may include a speaker that presents sound to the developer.

An example of a functional configuration of the application generation apparatus 10 according to the embodiment of the present disclosure has been described.

### [1.3. Example of Functional Configuration of Server Apparatus]

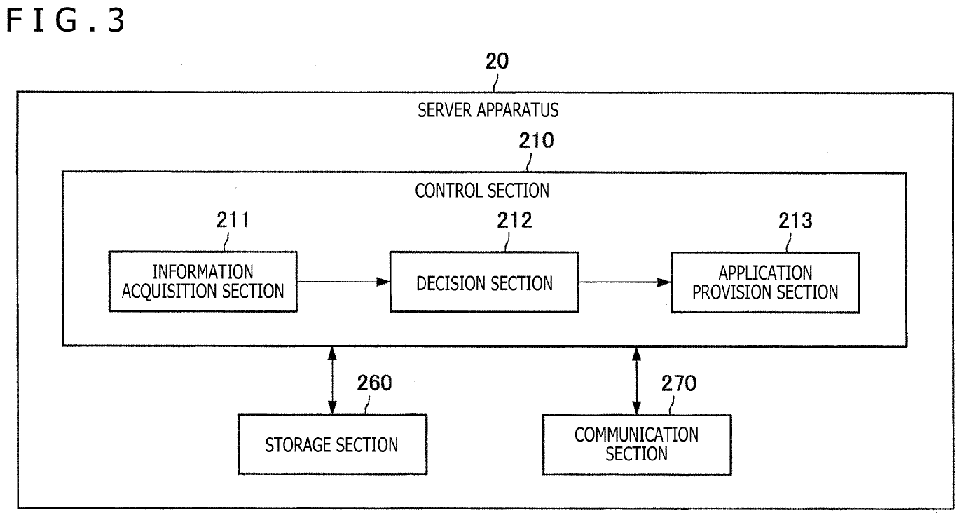

Now, an example of a functional configuration of the server apparatus 20 according to the embodiment of the present disclosure is described. FIG. 3 is a view depicting an example of a functional configuration of the server apparatus 20 according to the embodiment of the present disclosure. As depicted in FIG. 3, the server apparatus 20 includes a control section 210, a storage section 260, and a communication section 270.

The control section 210 executes control of the components of the server apparatus 20. The control section 210 may include, for example, one or a plurality of CPUs (Central Processing Units: central processing units) and so forth. In a case where the control section 210 includes a processing unit such as a CPU, such processing units may include electronic circuitry. The control section 210 can be implemented by a program executed by such a processing unit as just described. The control section 210 includes an information acquisition section 211, a decision section 212, and an application provision section 213. Details of the blocks are hereinafter described.

The storage section 260 includes a memory and is a recording medium that stores a program to be executed by the control section 210 and stores data necessary for execution of the program. Further, the storage section 260 temporarily stores data for arithmetic operation by the control section 210. The storage section 260 includes a magnetic storage section device, a semiconductor storage device, an optical storage device, a magneto-optical storage device or the like.

The communication section 270 includes a communication circuit and has a function for receiving data from the application generation apparatus 10 and the application execution apparatus 30 connected to the network through the network. Further, the communication section 270 has a function for transmitting data to the application generation apparatus 10 and the application execution apparatus 30 through the network.

An example of a functional configuration of the server apparatus 20 according to the embodiment of the present disclosure has been described.

### [1.4. Example of Functional Configuration of Application Execution Apparatus]

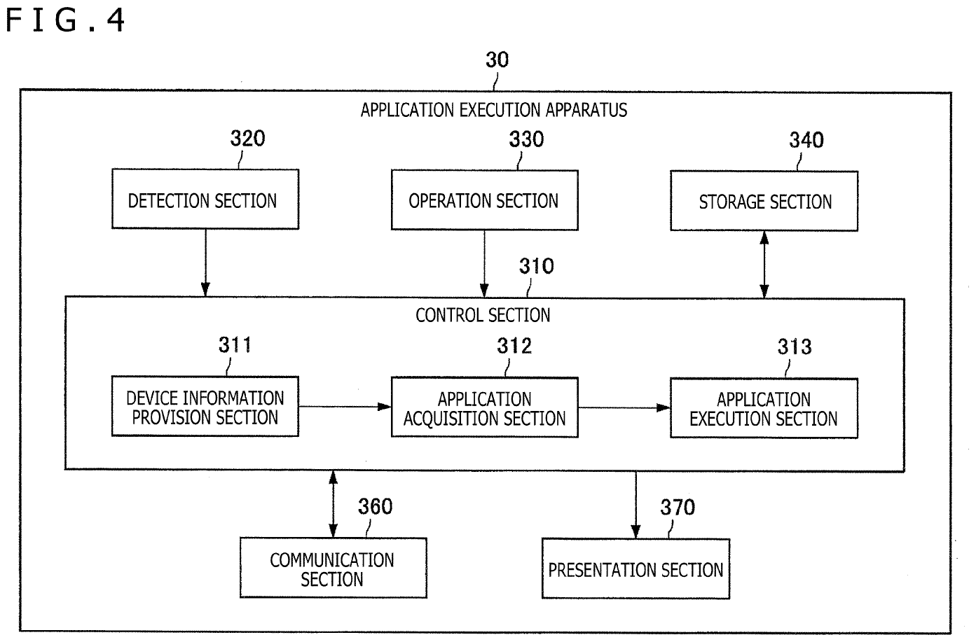

Now, an example of a functional configuration of the application execution apparatus 30 according to the embodiment of the present disclosure is described. FIG. 4 is a view depicting an example of a functional configuration of the application execution apparatus 30 according to the embodiment of the present disclosure. As depicted in FIG. 4, the application execution apparatus 30 includes a control section 310, a detection section 320, an operation section 330, a storage section 340, a communication section 360, and a presentation section 370.

The control section 310 executes control of the components of the application execution apparatus 30. The control section 310 may include, for example, one or a plurality of CPUs (Central Processing Units: central processing units) and so forth. In a case where the control section 310 includes a processing unit such as a CPU, such processing unit may include electronic circuitry. The control section 310 can be implemented by a program executed by such a processing unit as just described. The control section 310 includes a device information provision section 311, an application acquisition section 312, and an application execution section 313. Details of the blocks are hereinafter described.

The detection section 320 includes an equipped device (device necessary for recognition), and data necessary for recognition is detected by the equipped device. As described hereinabove, the equipped device is not restricted to a specific device. For example, the equipped device may include a camera, may include a mike, or may include a sensor different from the camera and the mike. The data necessary for recognition detected by the detection section 320 is provided to the control section 310 and is utilized for recognition (utilized for execution of the application).

The operation section 330 has a function of accepting an input of an operation by a user. In the embodiment of the present disclosure, principally a case in which the operation section 330 includes a button is assumed. However, the operation section 330 is not limited to the case in which it includes a button. For example, the operation section 330 may include a touch panel, may include a touch pad, may include a switch, may include a lever, may include a mouse, or may include a keyboard. Further, the operation section 330 may include a mike that detects voice of the user and may include an image sensor that detects a gaze of the user.

The storage section 340 includes a memory and is a recording medium that stores a program to be executed by the control section 310 and stores data necessary for execution of the program. Further, the storage section 340 temporarily stores data for arithmetic operation by the control section 310. The storage section 340 includes a magnetic storage section device, a semiconductor storage device, an optical storage device, a magneto-optical storage device or the like.

The communication section 360 includes a communication circuit and has a function for receiving data from the server apparatus 20 connected to the network through the network. Further, the communication section 360 has a function for transmitting data to the server apparatus 20 through the network.

The presentation section 370 has a function for presenting information to the user. The type of the presentation section 370 is not restrictive. For example, the presentation section 370 may include a display capable of performing viewable display to the developer, and the display may be a liquid crystal display, may be an organic EL (Electro-Luminescence) display, or may be some other display. Alternatively, the presentation section 370 may include a tactile presentation device that presents a sense of touch to the user or may include a speaker that presents sound to the user.

An example of a functional configuration of the application execution apparatus 30 according to the embodiment of the present disclosure has been described.

### [1.5. Example of Various Kinds of Information]

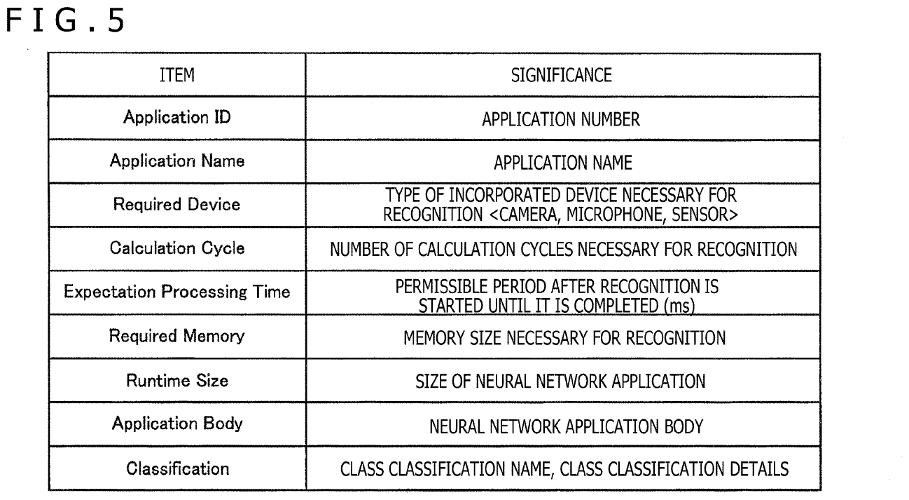

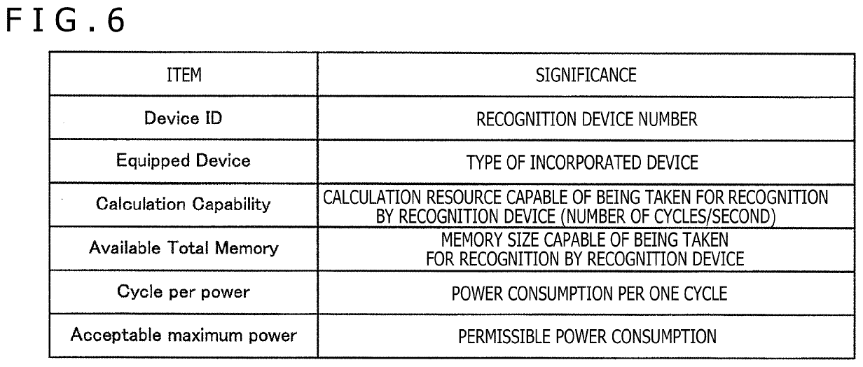

Examples of various kinds of information used by the information processing system 1 are described with reference to FIGS. 5 and 6. FIG. 5 is a view depicting an example of information provided from the application generation apparatus 10 to the server apparatus 20. Referring to FIG. 5, as an example of information provided from the application generation apparatus 10 to the server apparatus 20, feature data of an application is depicted. The feature data of the application is automatically acquired by the application generation apparatus 10 after generation of a neural network application is completed by the application generation apparatus 10.

The feature data of the application includes, as depicted in FIG. 5, an application number, an application name, a type of an equipped device necessary for recognition (type of an equipped device necessary for execution of the application), the number of calculation cycles necessary for recognition (the number of calculation cycles necessary for execution of the application), permissible period after recognition is started until the recognition is completed (permissible period after starting to ending of execution of the application), a memory size necessary for recognition (memory size necessary for execution of the application), a size of the neural network application, a neural network application body, a class classification name, and class classification details.

The application name is information capable of uniquely specifying the application. For example, the application name may be a name of a dataset used for learning, may be MNIST (Mixed National Institute of Standards and Technology database), may be ImageNet, or may be some other name.

The class classification name may be a name of class classification obtained as a result of the recognition (that is, a type of a result of execution obtained by execution of the application). For example, in a case where the application name is MNIST, the class classification name may be character numeral recognition or the like. Alternatively, in a case where the application name is ImageNet, the class classification name may be guitar recognition.

The details of the class classification may be details of class classification obtained as a result of the recognition (name of the recognition target). For example, in a case where the application name is MNIST, the details of the class classification may be a particular numeral such as “0,” “1” . . . , “9.” Alternatively, in a case where the application name is ImageNet, the details of the class classification may be such a particular guitar name as “Stratocaster,” “Telecaster,” “Mustang,” or “Les Paul.”

If each of the application generation apparatus 10 (and other application generation apparatus) individually generates an application, then it provides feature data of the generated application to the server apparatus 20. In such a manner, the server apparatus 20 registers feature data of applications provided individually from the application generation apparatus 10 (and other application generation apparatus) into an application information database (DB).

FIG. 6 is a view depicting an example of device information provided from the application execution apparatus 30 to the server apparatus 20. Referring to FIG. 6, an example of device information provided from the application execution apparatus 30 to the server apparatus 20 is depicted. The device information is automatically acquired by the application execution apparatus 30 on the basis of an operation by the user (for example, an operation for placing an operation mode into an update mode) (or automatically) and is provided from the application execution apparatus 30 to the server apparatus 20.

As depicted in FIG. 6, the device information includes a recognition device number, a type of an equipped device (type of a device capable of being utilized for execution of the application), a calculation resource that can be taken for recognition by the recognition device (can be taken for execution of the application by the recognition device) (the number of calculation cycles/second), a memory size capable of being taken for recognition by the recognition device (taken for execution of the application by the recognition device), power consumption per one cycle, and permissible power consumption.

Here, the calculation resource (the number of calculation cycles/second) that can be taken for recognition by the recognition device is applicable to the example of the “information related to the computing power” described hereinabove. Also, the memory size capable of being taken for recognition by the recognition device is applicable to the example of the “information related to the computing power” described hereinabove. Also, the power consumption per one cycle is applicable to the example of the “information related to the computing power” described hereinabove.

The application execution apparatus 30 (or another application execution apparatus) establishes connection to the server apparatus 20 on the basis of an operation by the user (or an operation for placing the operation mode to an update mode) (or automatically) and provides device information of the application execution apparatus 30 itself to the server apparatus 20. The server apparatus 20 registers the device information provided from the application execution apparatus 30 (or the other application execution apparatus) in such a manner into the device information database (DB). Further, the server apparatus 20 returns the application according to the device information to the application execution apparatus 30 (or the other application execution apparatus).

Examples of various kinds of information used by the information processing system 1 have been described.

### [1.6. Operation of Information Processing System]

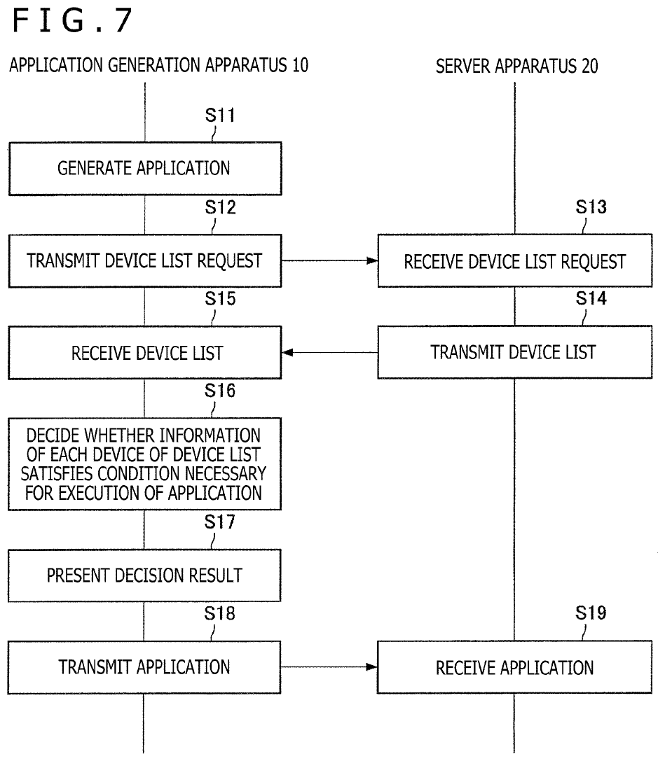

An example of operation of the information processing system 1 according to the embodiment of the present disclosure is described with reference to FIGS. 7 to 10.

### (Operation at Time of Application Registration)

FIG. 7 is a flow chart depicting an example of operation at a time of application registration of the information processing system 1 according to the embodiment of the present disclosure. It is to be noted that the flow chart depicted in FIG. 7 merely indicates one example of operation at the time of application registration by the information processing system 1 according to the embodiment of the present disclosure. Accordingly, operation at the time of application registration by the information processing system 1 according to the embodiment of the present disclosure is not restricted to the example depicted in FIG. 7.

As depicted in FIG. 7, the application generation apparatus 10 generates an application on the basis of an operation by a developer of the application (or automatically) (S11). Here, a case is supposed in which device information of the application execution apparatus 30 (or of the other application execution apparatus) is uploaded already in the server apparatus 20. Accordingly, the application generation apparatus 10 preferably generates an application while referring to the device information uploaded in the server apparatus 20. This makes it possible to improve the development efficiency of an application.

In particular, in the application generation apparatus 10, the decision section 111 transmits a device list request to the server apparatus 20 through the communication section 160 on the basis of an operation by the developer of the application (or automatically) (S12). In the server apparatus 20, the communication section 270 receives the device list request (S13). Then, in a case where one or a plurality of pieces of device information is acquired from the device information database (DB), the communication section 270 transmits (returns) the one or plurality of pieces of device information as a device list to the application generation apparatus 10 (S14). In the application generation apparatus 10, the decision section 111 receives the device list from the server apparatus 20 through the communication section 160 (S15).

It is to be noted that the one or plurality of pieces of device information returned from the server apparatus 20 to the application generation apparatus 10 may be all device information registered in the device information database (DB) or may be restricted only to the device information of the application execution apparatus 30 designated by the developer. The decision section 111 decides whether or not each piece of device information of the device list satisfies a condition necessary for recognition (condition necessary for execution of the application) (S16). The condition necessary for recognition is not restrictive.

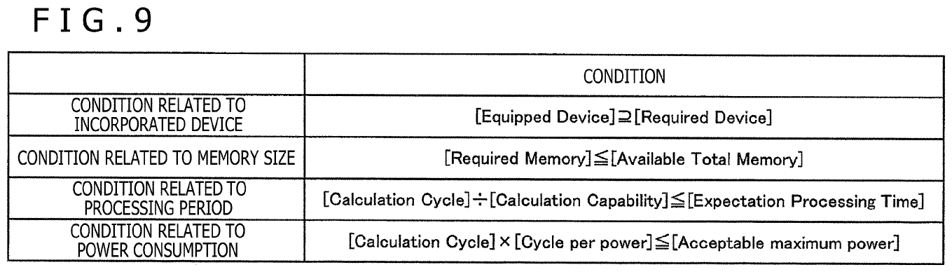

FIG. 9 is a view depicting an example of the condition necessary for recognition. Referring to FIG. 9, as the example of the condition necessary for recognition, a “condition related to equipped device,” a “condition related to memory size,” a “condition related to processing period,” and a “condition related to power consumption” are depicted. In the embodiment of the present disclosure, principally a case in which the condition necessary for recognition includes all of the conditions mentioned is supposed. However, the condition necessary for recognition may include only some of the conditions mentioned. Further, the condition necessary for recognition may include a “condition related to size of application.” In consideration of communication load, the “condition related to size of application” may be a condition that the size of the application is equal to or smaller than a threshold value.

Here, the “condition related to memory size” is applicable to an example of a condition related to the computing power necessary for recognition (condition related to the computing power necessary for execution of the application). Also, the “condition related to processing period” is applicable to the example of the condition related to the computing power necessary for recognition (condition related to the computing power necessary for execution of the application). Further, the “condition related to power consumption” is also applicable to an example of the condition related to the computing power necessary for recognition (condition related to the computing power necessary for execution of the application).

The “condition related to equipped device” is applicable to a condition related to the type of an equipped device. It is sufficient if only the type of the equipped device satisfies the “condition related to equipped device.” In particular, as depicted in FIG. 9, the “condition related to equipped device” may be a condition that a set of “type of equipped device necessary for recognition (Required Device)” of the feature data of the application (FIG. 5) is included in a set of “type of equipped device (Equipped Device)” of the device information (FIG. 6). An application execution apparatus by which such a condition as just described is satisfied can detect data necessary for recognition.

The “condition related to memory size” is applicable to the condition related to the memory size that can be taken for recognition by the recognition device. Only it is necessary that the “condition related to memory size” is satisfied by the memory size that can be taken for recognition by the recognition apparatus. In particular, as depicted in FIG. 9, the “condition related to memory size” may be a condition that the “memory size necessary for recognition (Required Memory)” of the feature data of the application (FIG. 5) is equal to or smaller than the “memory size (Available Total Memory) that can be taken for recognition by the recognition device” of the device information (FIG. 6). The application execution apparatus by which such a condition as just described is satisfied may have a memory size necessary for recognition.

The “condition related to processing period” is applicable to a condition related to the calculation resource (the number of calculation cycles/second) that can be taken for recognition by the recognition device. Only it is necessary that the “condition related to processing period” is satisfied by the calculation resource (the number of calculation cycles) that can be taken for recognition by the recognition device.

In particular, the “condition related to processing period” may be a condition that a processing period based on the “the number of calculation cycles necessary for recognition (Calculation Cycle)” of the feature data of the application (FIG. 5) and the “calculation resource (the number of calculation cycles/second) (Calculation Capability) that can be taken for recognition by the recognition device” of the device information (FIG. 6) (more particularly, as depicted in FIG. 9, a processing period obtained by dividing the “the number of calculation cycles necessary for recognition (Calculation Cycle)” by the “calculation resource that can be taken for recognition by the recognition device (the number of calculation cycles/second) (Calculation Capability)”), is equal to or shorter than the “permissible period (Expectation Processing Time) after recognition is started until it is completed” of the feature data of the application (FIG. 5). An application execution apparatus by which such a condition as just described is satisfied has a calculation resource necessary for recognition.

The “condition related to power consumption” is applicable to a condition related to electric power consumed for recognition by the recognition device. Only it is necessary for the “condition related to power consumption” to be satisfied by electric power consumed for recognition by the recognition device.

In particular, the “condition related to power consumption” may be a condition that the period of time spent on the basis of the “the number of calculation cycles (Calculation Cycle) necessary for recognition” of the feature data of the application (FIG. 5) and the “power consumption per one cycle (Cycle per power)” of the device information (FIG. 6) (more particularly, as depicted in FIG. 9, power consumption obtained by multiplying the “number of calculation cycles (Calculation Cycle) necessary for recognition” by the “power consumption per one cycle (Cycle per power)”) is equal to or lower than the “permissible power consumption (Acceptable maximum power)” of the device information (FIG. 6). An application execution apparatus by which such condition as just described is satisfied can perform recognition with electric power equal to or less than the permissible power consumption.

It is considered that an application execution apparatus that provides device information in which even one of conditions necessary for recognition (in the example depicted in FIG. 9, the “condition related to equipped device,” “condition related to memory size,” “condition related to processing period,” and “condition related to power consumption”) is not satisfied is not suitable for execution of the application. On the other hand, it is considered that an application execution apparatus that provides device information in which all of the conditions necessary for recognition are satisfied is suitable for execution of the application.

The presentation controlling section 112 controls the presentation section 170 to present a decision result based on the decision regarding whether or not such conditions as described above are satisfied, and the presentation section 170 presents the decision result under the control of the presentation controlling section 112 (S17). For example, the presentation controlling section 112 may control the presentation section 170 to present a predetermined alert in a case where there is even one of the “condition related to equipped device,” “condition related to memory size,” “condition related to processing period,” and “condition related to power consumption” that is not satisfied.

The type of the alert is not restrictive. For example, the alert may include predetermined display (for example, a predetermined text, a predetermined image or the like) or may include predetermined sound. Further, the presentation controlling section 112 may control the presentation section 170 such that an item corresponding to any condition that is not satisfied (item in the device information and item in the feature data of the application) and a value of the item are presented together with the predetermined alert.

In the application generation apparatus 10, the application registration processing section 113 transmits (registers) the feature data of the application (including the application) to (into) the server apparatus 20 through the communication section 160 on the basis of an operation by the developer of the application (or automatically) (S18). In the server apparatus 20, the communication section 270 receives the feature data of the application (S19). The feature data of the application is added to the device information database (DB).

### (Operation at Time of Execution of Application)

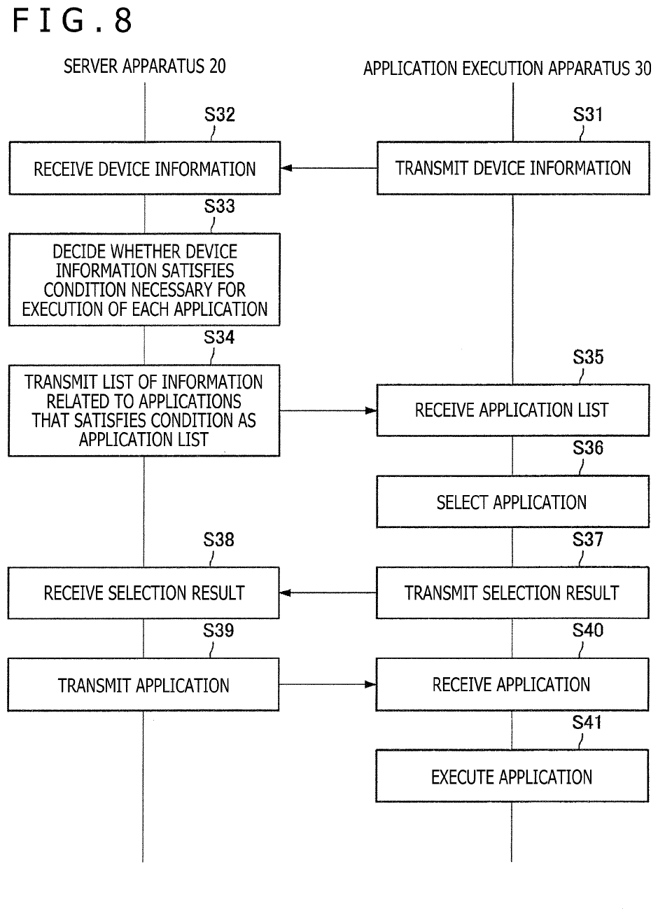

FIG. 8 is a flow chart depicting an example of operation at a time of application execution of the information processing system 1 according to the embodiment of the present disclosure. It is to be noted that the flow chart depicted in FIG. 8 merely indicates an example of operation at the time application execution by the information processing system 1 according to the embodiment of the present disclosure. Accordingly, operation at the time of application execution by the information processing system 1 according to the embodiment of the present disclosure is not restricted to the example depicted in FIG. 8.

As depicted in FIG. 8, in the application execution apparatus 30, the device information provision section 311 establishes connection to the server apparatus 20 on the basis of an operation by the user (for example, an operation for placing the operation mode into an update mode) (or automatically) and transmits (provides) device information of the application execution apparatus 30 itself to the server apparatus 20 through the communication section 360 (S31). In the server apparatus 20, the information acquisition section 211 receives (acquires) the device information from the application execution apparatus 30 through the communication section 270 (S32).

The decision section 212 decides on the basis of the device information received by the information acquisition section 211 and the application information database (DB) whether the device information satisfies a condition necessary for recognition by each application (condition necessary for execution of each application) (S33). Here, since the “condition necessary for recognition” used by the decision section 212 may be similar to the “condition necessary for recognition” used by the decision section 111 in the application generation apparatus 10, detailed description of the same is omitted.

It is considered that an application by which even one of conditions necessary for recognition (in the example depicted in FIG. 9, the “condition related to equipped device,” “condition related to memory size,” “condition related to processing period,” and “condition related to power consumption”) is not satisfied is not suitable for execution by the application execution apparatus 30. On the other hand, it is considered that an application by which all of the conditions necessary for recognition are satisfied is suitable for execution by the application execution apparatus 30.

The application provision section 213 acquires the application name, the class classification, and the details of the class classification from within the feature data (FIG. 5) of the application by which all of the conditions necessary for recognition are satisfied from the application information database (DB). Further, the application provision section 213 calculates the processing period described hereinabove based on the “the number of calculation cycles (Calculation Cycle) necessary for recognition” of the feature data (FIG. 5) of the application by which all of the conditions necessary for recognition are satisfied and the “calculation resource (the number of calculation cycles/second) (Calculation Capability) that can be taken for recognition by the recognition device” of the device information (FIG. 6).

The application provision section 213 transmits a list of the information (application name, class classification, details of class classification, and processing period) related to the applications by which all of the conditions necessary for the recognition are satisfied as an application list to the application execution apparatus 30 through the communication section 270 (S34). Also, application numbers are added in the application list. It is to be noted that, in the embodiment of the present disclosure, principally a case is supposed in which the information related to the application includes all of the application name, class classification, details of class classification, and processing period. However, the information related to the application may include only part of the application name, class classification, details of class classification, and processing period.

In the application execution apparatus 30, the application acquisition section 312 receives (acquires) the application list through the communication section 360 (S35). Then, the application acquisition section 312 controls such that the application list is displayed by a display device of the terminal apparatus 40. The display device of the terminal apparatus 40 displays the application list under the control of the application acquisition section 312.

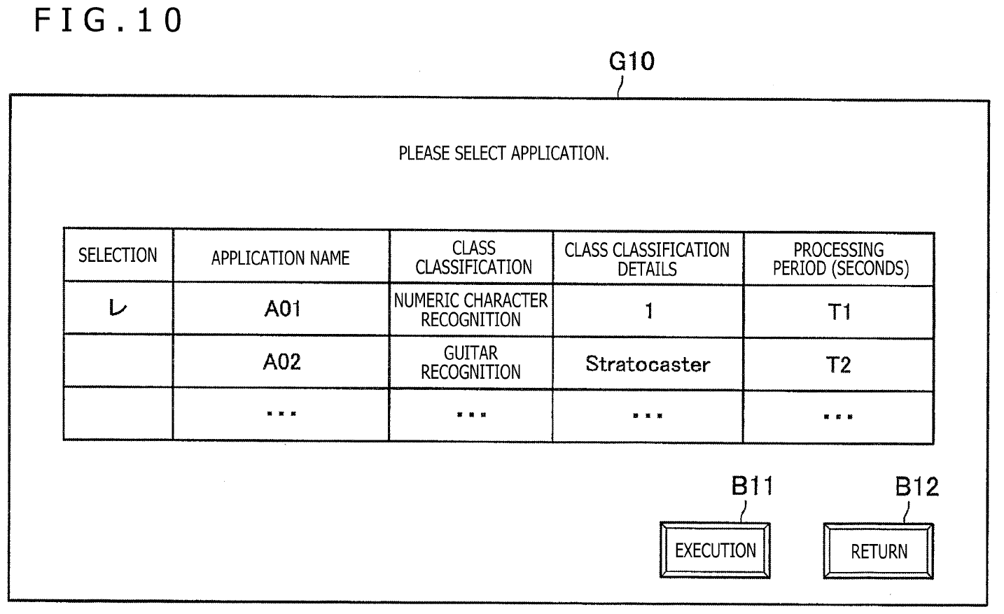

FIG. 10 is a view depicting an example of an application selection screen image. Referring to FIG. 10, an application selection screen image G10 is depicted. On the application selection screen image G10, a list of information (application name, class classification, details of class classification, and processing period) related to the application by which all of the conditions necessary for recognition are satisfied is displayed as an application list.

The user would refer to the application list and select an application to be executed by the application execution apparatus 30 through the inputting device of the terminal apparatus 40 and then select an execution button B11 through the inputting device of the terminal apparatus 40. The application acquisition section 312 transmits a number corresponding to the selected application (application number) as a selection result to the server apparatus 20 through the communication section 360 (S37). To the selection result, the recognition device number is also added. It is to be noted that, if a return button B12 is selected through the inputting device of the terminal apparatus 40 by the user, then a preceding screen image to the application selection screen image G10 is restored.

In the server apparatus 20, the application provision section 213 receives the selection result through the communication section 270 (S38) and transmits (returns) an application (application body) corresponding to the selection result (selected application number) to the application execution apparatus 30 corresponding to the recognition device number through the communication section 270 (S39). In the application execution apparatus 30, the application acquisition section 312 receives (acquires) the application through the communication section 360 (S40).

The application execution section 313 installs the application and restarts the application execution apparatus 30 to place the operation mode into an application execution mode. Then, the application execution section 313 executes the application (starts recognition based on the application) (S41).

An example of operation of the information processing system 1 according to the embodiment of the present disclosure has been described.

### 2. EXAMPLE OF HARDWARE CONFIGURATION

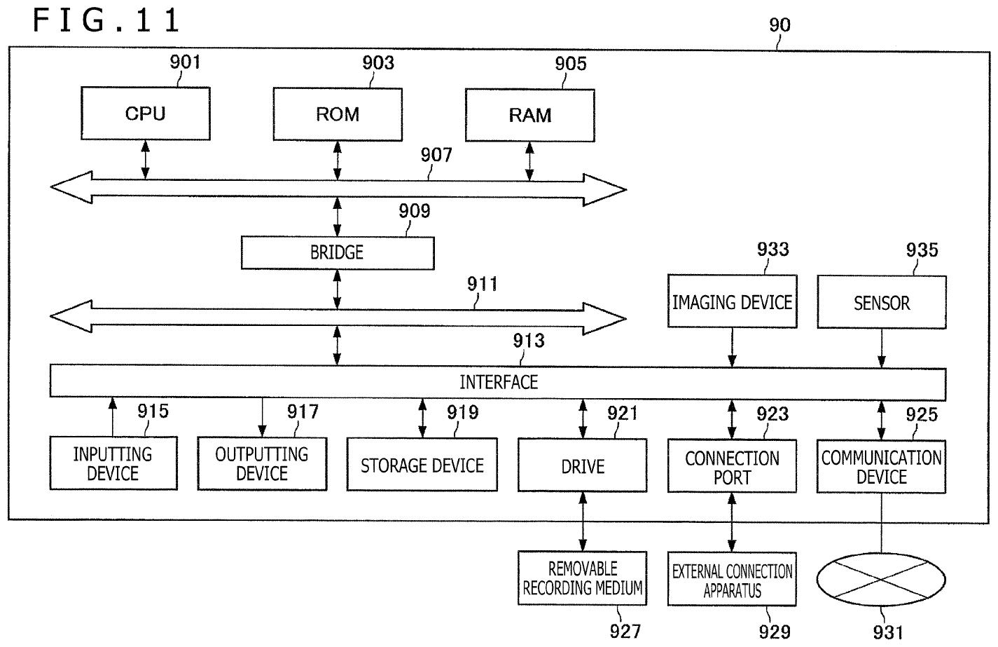

Now, an example of a hardware configuration of a computer 90 as an example of a hardware configuration of each of the application generation apparatus 10, the server apparatus 20, and the application execution apparatus 30 according to the embodiment of the present disclosure is described with reference to FIG. 11. FIG. 11 is a block diagram depicting an example of a hardware configuration of the computer 90. It is to be noted that the hardware ware configuration of each of the application generation apparatus 10, the server apparatus 20, and the application execution apparatus 30 may not coincide fully with the example of the hardware configuration depicted in FIG. 11 (for example, an unnecessary component may be deleted from the example of the hardware configuration depicted in FIG. 11).

As depicted in FIG. 11, the computer 90 includes a CPU (Central Processing unit) 901, a ROM (Read Only Memory) 903, and a RAM (Random Access Memory) 905. Further, the computer 90 includes a host bus 907, a bridge 909, an external bus 911, an interface 913, an inputting device 915, an outputting device 917, a storage device 919, a drive 921, a connection port 923, and a communication device 925. Further, the computer 90 includes an imaging device 933 and a sensor 935. The computer 90 may include, in place of or together with the CPU 901, such a processing circuit as is called a DSP (Digital Signal Processor) or an ASIC (Application Specific Integrated Circuit).

The CPU 901 functions as an arithmetic processing device and a control device and controls overall operation or part of operation in the computer 90 in accordance with various programs recorded in the ROM 903, the RAM 905, the storage device 919, or a removable recording medium 927. The ROM 903 stores programs, arithmetic parameters and so forth that are used by the CPU 901. The RAM 905 temporarily stores programs to be used in execution of the computer 90, parameters that suitably change in the execution and so forth. The CPU 901, the ROM 903, and the RAM 905 are connected to each other by the host bus 907 including an internal bus such as a CPU bus. Further, the host bus 907 is connected to the external bus 911 such as a PCI (Peripheral Component Interconnect/Interface) bus through the bridge 909.

The inputting device 915 is a device that is operated by the user such as, for example, a mouse, a keyboard, a touch panel, a button, a switch, and a lever. The inputting device 915 may include a microphone that detects voice of the user. The inputting device 915 may be a remote control device that uses, for example, infrared rays or some other radio waves or may be an external connection apparatus 929 ready for operation of the computer 90. The inputting device 915 includes an input controlling circuit that generates an input signal on the basis of information inputted by the user and outputs the input signal to the CPU 901. The user would operate the inputting device 915 to input various kinds of data or an instruction of processing operation to the computer 90. Also, the imaging device 933 hereinafter described can function as an inputting device by capturing an image of a movement of a hand of the user, a finger of the user or the like. At this time, a pointing position may be determined according to the movement of the hand or the direction of the finger.

The outputting device 917 includes a device that can visually or auditorily notify the user of acquired information. The outputting device 917 may be a display device such as, for example, an LCD (Liquid Crystal Display), a PDP (Plasma Display Panel), an organic EL (Electro-Luminescence) display, or a projector, a hologram display device, a sound outputting device such as a speaker and a headphone as well as a printer device and so forth. The outputting device 917 outputs a result obtained by processing of the computer 90 as a video such as a text or an image or an audio such as voice or acoustic. Further, the outputting device 917 may include a lamp for enlightening the surroundings.

The storage device 919 is a device for data storage configured as an example of a storage section of the computer 90. The storage device 919 includes, for example, a magnetic storage section device such as an HDD (Hard Disk Drive), a semiconductor storage device, an optical storage device, or a magneto-optical storage device. The storage device 919 stores programs to be executed by the CPU 901 and various kinds of data, and various kinds of data and so forth acquired from the outside.

The drive 921 is a reader/writer for the removable recording medium 927 such as a magnetic disk, an optical disk, a magneto-optical disk, or a semiconductor memory and is built in or externally provided for the computer 90. The drive 921 reads out information recorded in the removable recording medium 927 loaded therein and outputs the information to the RAM 905. Further, the drive 921 writes a record on the removable recording medium 927 loaded therein.

The connection port 923 is a port for directly connecting an apparatus to the computer 90. The connection port 923 may be, for example, a USB (Universal Serial Bus) port, an IEEE 1394 port, a SCSI (Small Computer System Interface) port or the like. Alternatively, the connection port 923 may be an RS-232C port, an optical audio terminal, an HDMI (registered trademark) (High-Definition Multimedia Interface) port or the like. By connecting the external connection apparatus 929 to the connection port 923, various kinds of data can be exchanged between the computer 90 and the external connection apparatus 929.

The communication device 925 is a communication interface including, for example, a communication device for connecting to a communication network 931. The communication device 925 may be a communication card, for example, for a wired or wireless LAN (Local Area Network), Bluetooth (registered trademark), or a WUSB (Wireless USB) or the like. Alternatively, the communication device 925 may be a router for optical communication, a router for the ADSL (Asymmetric Digital Subscriber Line), modems for various kinds of communication or the like. The communication device 925 communicates a signal and so forth, for example, with the Internet or some other communication apparatus using a predetermined protocol such as a TCP/IP. Further, the communication network 931 connected to the communication device 925 is a network connected by wired or wireless connection and is, for example, the Internet, a home LAN, infrared communication, radio wave communication, satellite communication or the like.

The imaging device 933 is a device that captures an image of a real space to generate a captured image by using such various members as an imaging element such as, for example, a CCD (Charge Coupled Device) imaging element or a CMOS (Complementary Metal Oxide Semiconductor) imaging element and a lens for controlling formation of an image of an imaging target on the imaging element. The imaging device 933 may capture a still picture or may capture a moving picture.

The sensor 935 includes various sensors such as, for example, a distance measurement sensor, an acceleration sensor, a gyro sensor, a geomagnetic sensor, an optical sensor, and a sound sensor. The sensor 935 acquires information related to a state of the computer 90 itself such as, for example, a posture of a housing of the computer 90 and information related to a surrounding environment of the computer 90 such as brightness or noise around the computer 90. Further, the sensor 935 may include a GPS sensor that receives GPS (Global Positioning System) signals to measure a latitude, a longitude, and a height of the device.

### 3. CONCLUSION

As described above, according to the embodiment of the present disclosure, there is provided an information processing apparatus including a device information provision section configured to provide information related to computing power of a device, and an application acquisition section configured to acquire an application on the basis that the information related to the computing power satisfies a condition related to computing power necessary for execution of the application. According to such a configuration as just described, an application more suitable for execution by the information processing apparatus is downloaded to the information processing apparatus.

Further, the application generation apparatus preferably generates an application while referring to device information uploaded to the information providing apparatus. This makes it possible to improve the development efficiency of the application. For example, in the application generation apparatus, the presentation controlling section may control such that a predetermined alert is presented by the presentation section in a case where there is device information in which even one of conditions related to the computing power is not satisfied.

Although the preferred embodiment of the present disclosure has been described in detail with reference to the accompanying drawings, the technical scope of the present disclosure is not limited to such example. It is apparent that persons who have common knowledge in the technical field to which the present disclosure pertains could have conceived various alterations or modifications within the scope of the technical idea described in the claims, and it is also recognized that they naturally fall within the technical scope of the present disclosure.

For example, the foregoing description is directed principally to a case in which an application selected by the user on the basis of an application list from among applications that satisfy a condition necessary for recognition is acquired by the application execution apparatus 30. However, selection of an application based on the application list may otherwise be performed automatically by the application execution apparatus 30 in place of the user.

For example, in the application execution apparatus 30, in a case where the application acquisition section 312 can acquire environment information from data (detection data) detected by the detection section 320, the application acquisition section 312 may select an application on the basis of a list of information related to applications (application list) and the environment information. For example, the application acquisition section 312 may select an application that conforms to the environment information on the basis of the application list. Further, the application acquisition section 312 may acquire the selected application from the server apparatus 20 through the communication section 360.

For example, in a case where the list of information related to applications (application list) includes a type of an equipped device necessary for recognition, the application acquisition section 312 may select an application in a case where the type of the equipped device corresponding to the environment information and the type of the equipped device necessary for recognition conform to each other.

For example, in a case where the environment information indicates a time zone in the daytime and besides in a case where the type of the equipped device corresponding to the time zone in the daytime is a camera, the application acquisition section 312 may select an application in regard to which the type of the equipped device necessary for recognition is a camera. On the other hand, in a case where the environment information indicates a time zone at night and besides in a case where the type of the equipped device corresponding to the time zone at night is a mike, the application acquisition section 312 may select an application with regard to which the type of the equipped device necessary for recognition is a mike.

For example, the environment information may be obtained in any manner. For example, in a case where the luminance of image data obtained by the camera of the application execution apparatus 30 is higher than a first threshold value, it may be decided that the environment information indicates a time zone in the daytime, but in a case where the luminance of the image data is lower than a second threshold value, it may be decided that the environment information indicates a time zone at night.

Further, the foregoing description is directed principally to a case in which one application is selected by the user or the application execution apparatus 30 and executed by the application execution apparatus 30. However, if the resource of the application execution apparatus 30 does not become short, plural applications may be selected simultaneously and acquired from the server apparatus 20 and may be executed in parallel by the application execution section 313. In other words, even if conditions necessary for recognition regarding plural applications are integrated, in a case where the condition after the integration is satisfied, the plural applications may be selected simultaneously and acquired from the server apparatus 20 and then executed in parallel by the application execution section 313.

For example, even if conditions related to the computing power necessary for execution of plural applications are added, in a case where the condition after the addition is satisfied by the information related to the computing power, the application acquisition section 312 may acquire the plural applications. Then, the application execution section 313 may execute the plural applications in parallel. At this time, in order to prevent conflict with the same equipped device, the equipped device necessary for recognition is preferably different in type between the plural applications. For example, one of the applications may be an application for which the type of the equipped device necessary for recognition is a camera while the other is an application in regard to which the type of the equipped device necessary for recognition is a mike.

Further, the foregoing description is directed principally to a case in which an application selected on the basis of an application list from among applications in which a condition necessary for recognition is satisfied is acquired by the application execution apparatus 30. However, selection of an application based on the application list may be omitted suitably. In other words, an application with regard to which it is decided by the decision section 212 that a condition necessary for recognition is satisfied in the server apparatus 20 may be provided to the application execution apparatus 30 and acquired by the application acquisition section 312 of the application execution apparatus 30.

Also, it is possible to generate a program for causing hardware such as a CPU, a ROM, and a RAM built in a computer to exert functions equivalent to the functions the control section 110 described hereinabove has. Also, a computer-readable recording medium in which the program is recorded can be provided. Similarly, it is also possible to generate a program for causing the hardware to exert functions equivalent to the functions the control section 210 has. Also, a computer-readable recording medium in which the program is recorded can be provided. Also, it is possible to generate a program for causing the hardware to exert functions equivalent to the functions the control section 310 has. Also, a computer-readable recording medium in which the program is recorded can be provided.

Further, for example, if the functions of the devices described above are implemented, then the positions of the configurations of the devices are not specifically restrictive. Part or all of the configurations of the application generation apparatus 10 or the application execution apparatus 30 may be performed by the server apparatus 20. As a particular example, the decision section 111 in the application generation apparatus 10 may otherwise exist in the server apparatus 20 (for example, it may be formed common to the decision section 212 of the server apparatus 20). Further, the configuration for selecting an application on the basis of an application list may exist in the server apparatus 20 in place of the application execution apparatus 30.

Further, the advantageous effects described in the present specification are explanatory or illustrative to the last and are not restrictive. That is, the technology according to the present disclosure can achieve other advantageous effects apparent to those skilled in the art from the description of the present specification together with or in place of the advantageous effects described hereinabove.

It is to be noted that such configurations as described below also belong to the technical scope of the present disclosure.

(1)

An information processing apparatus including:

a device information provision section configured to provide information related to computing power of a device; and

an application acquisition section configured to acquire an application, on the basis that the information related to the computing power satisfies a condition related to computing power necessary for execution of the application.

(2)

The information processing apparatus according to (1) above, in which

the information related to the computing power includes the number of cycles per unit time that is capable of being taken for execution of the application by the device; and

the condition related to the computing power includes a condition that a processing period based on the number of cycles per unit time and the number of cycles necessary for execution of the application is equal to or shorter than a permissible period.

(3)

The information processing apparatus according to (1) or (2) above, in which

the information related to the computing power includes a memory size that is capable of being taken for execution of the application by the device; and

the condition related to the computing power includes a condition that a memory size necessary for execution of the application is equal to or smaller than the memory size that is capable of being taken for execution of the application.

(4)

The information processing apparatus according to any one of (1) to (3) above, in which

the information related to the computing power includes power consumption per one cycle of the device; and

the condition related to the computing power includes a condition that power consumption based on the power consumption per one cycle and the number of cycles necessary for execution of the application is equal to or lower than permissible power consumption.

(5)

The information processing apparatus according to any one of (1) to (4) above, in which

the application acquisition section acquires the application on the basis that a type of a device that is capable of being utilized for execution of the application further satisfies a condition related to a type of a device necessary for execution of the application.

(6)

The information processing apparatus according to any one of (1) to (5) above, in which

the application includes an application that uses a neural network.

(7)

The information processing apparatus according to any one of (1) to (6) above, in which

the application acquisition section acquires information related to the application on the basis that the information related to the computing power satisfies a condition related to computing power necessary for execution of the application and acquires the application in a case where the application is selected on the basis of the information related to the application.

(8)

The information processing apparatus according to (7) above, in which

the application acquisition section controls a display device such that the information related to the application is displayed and acquires the application in a case where the application is selected by a user.

(9)

The information processing apparatus according to (7) above, in which

the information related to the application includes a type of a result of execution obtained by execution of the application.

(10)

The information processing apparatus according to (7) above, in which

the application acquisition section acquires the application in a case where the application is selected on the basis of the information related to the application and environment information.

(11)

The information processing apparatus according to (10) above, in which

the information related to the application includes a type of a device necessary for execution of the application; and

the application acquisition section selects the application in a case where a type of a device corresponding to the environment information and a type of a device necessary for execution of the application conform to each other.

(12)

The information processing apparatus according to any one of (1) to (11) above, further including:

an application execution section configured to execute the application.

(13)

The information processing apparatus according to any one of (1) to (12) above, in which

the application acquisition section acquires a plurality of applications on the basis that the information related to the computing power satisfies a condition related to computing power necessary for execution of the plurality of applications.

(14)

An information processing method including:

providing, by a processor, information related to computing power of a device; and

acquiring, by the processor, an application on the basis that the information related to the computing power satisfies a condition related to computing power necessary for execution of the application.

(15)

An information providing apparatus including:

a decision section configured to decide whether or not information related to computing power of a device satisfies a condition related to computing power necessary for execution of an application; and

a provision section configured to provide the application on the basis that the information related to the computing power of the device satisfies the condition related to the computing power necessary for execution of the application.

(16)

An information providing method including:

deciding, by a processor, whether or not information related to computing power of a device satisfies a condition related to computing power necessary for execution of an application; and

providing, by the processor, the application on the basis that the information related to the computing power of the device satisfies the condition related to the computing power necessary for execution of the application.

(17)

A presentation controlling apparatus including:

a decision section configured to decide whether or not information related to computing power of a device satisfies a condition related to computing power necessary for execution of an application; and

a presentation controlling section configured to control presentation of a predetermined alert on the basis that the information related to the computing power of the device does not satisfy the condition related to the computing power necessary for execution of the application.

(18)

The presentation controlling apparatus according to (17) above, further including:

an application registration processing section configured to register the application into an information providing apparatus.

(19)

A presentation controlling method including:

deciding, by a processor, whether or not information related to computing power of a device satisfies a condition related to computing power necessary for execution of an application; and

controlling, by the processor, presentation of a predetermined alert on the basis that the information related to the computing power of the device does not satisfy the condition related to the computing power necessary for execution of the application.

(20)

An information processing system including:

an information processing apparatus; and

an information providing apparatus, in which

the information processing apparatus includes
a device information provision section configured to provide information related to computing power of a device to the information providing apparatus, and
an application acquisition section configured to acquire an application, from the information providing apparatus, on the basis that the information related to the computing power satisfies a condition related to computing power necessary for execution of the application, and

the information providing apparatus includes
a decision section configured to decide whether or not the information related to the computing power of the device satisfies the condition related to the computing power necessary for execution of the application, and
a provision section configured to provide the application to the information processing apparatus on the basis that the information related to the computing power of the device satisfies the condition related to the computing power necessary for execution of the application.

### REFERENCE SIGNS LIST

1: Information processing system
10: Application generation apparatus
110: Control section
111: Decision section
112: Presentation controlling section
113: Application registration processing section
120: Detection section
121: Camera
130: Operation section
140: Storage section
160: Communication section
170: Presentation section
20: Server apparatus
210: Control section
211: Information acquisition section
212: Decision section
213: Application provision section
260: Storage section
270: Communication section
30: Application execution apparatus
310: Control section
311: Device information provision section
312: Application acquisition section
313: Application execution section
320: Detection section
321: Camera
322: Mike
330: Operation section
340: Storage section
360: Communication section
370: Presentation section
390: Battery
40: Terminal apparatus

What is claimed is:

1. An information processing apparatus comprising:
a device information provision section configured to provide information related to computing power of a device; and
an application acquisition section configured to acquire an application, on a basis that the information related to the computing power satisfies a condition related to computing power necessary for execution of the application.

2. The information processing apparatus according to claim 1, wherein
the information related to the computing power includes the number of cycles per unit time that is capable of being taken for execution of the application by the device; and
the condition related to the computing power includes a condition that a processing period based on the number of cycles per unit time and the number of cycles necessary for execution of the application is equal to or shorter than a permissible period.

3. The information processing apparatus according to claim 1, wherein
the information related to the computing power includes a memory size that is capable of being taken for execution of the application by the device; and
the condition related to the computing power includes a condition that a memory size necessary for execution of the application is equal to or smaller than the memory size that is capable of being taken for execution of the application.

4. The information processing apparatus according to claim 1, wherein
the information related to the computing power includes power consumption per one cycle of the device; and
the condition related to the computing power includes a condition that power consumption based on the power consumption per one cycle and the number of cycles necessary for execution of the application is equal to or lower than permissible power consumption.

5. The information processing apparatus according to claim 1, wherein
the application acquisition section acquires the application on a basis that a type of a device that is capable of being utilized for execution of the application further satisfies a condition related to a type of a device necessary for execution of the application.

6. The information processing apparatus according to claim 1, wherein
the application includes an application that uses a neural network.

7. The information processing apparatus according to claim 1, wherein
the application acquisition section acquires information related to the application on the basis that the information related to the computing power satisfies a condition related to computing power necessary for execution of the application and acquires the application in a case where the application is selected on a basis of the information related to the application.

8. The information processing apparatus according to claim 7, wherein
the application acquisition section controls a display device such that the information related to the application is displayed and acquires the application in a case where the application is selected by a user.

9. The information processing apparatus according to claim 7, wherein
the information related to the application includes a type of a result of execution obtained by execution of the application.

10. The information processing apparatus according to claim 7, wherein
the application acquisition section acquires the application in a case where the application is selected on a basis of the information related to the application and environment information.

11. The information processing apparatus according to claim 10, wherein
the information related to the application includes a type of a device necessary for execution of the application; and
the application acquisition section selects the application in a case where a type of a device corresponding to the environment information and a type of a device necessary for execution of the application conform to each other.

12. The information processing apparatus according to claim 1, further comprising:
an application execution section configured to execute the application.

13. The information processing apparatus according to claim 1, wherein
the application acquisition section acquires a plurality of applications on a basis that the information related to the computing power satisfies a condition related to computing power necessary for execution of the plurality of applications.

14. An information processing method comprising:
providing, by a processor, information related to computing power of a device; and
acquiring, by the processor, an application on a basis that the information related to the computing power satisfies a condition related to computing power necessary for execution of the application.

15. An information providing apparatus comprising:
a decision section configured to decide whether or not information related to computing power of a device satisfies a condition related to computing power necessary for execution of an application; and
a provision section configured to provide the application on a basis that the information related to the computing power of the device satisfies the condition related to the computing power necessary for execution of the application.

16. An information providing method comprising:
deciding, by a processor, whether or not information related to computing power of a device satisfies a condition related to computing power necessary for execution of an application; and
providing, by the processor, the application on a basis that the information related to the computing power of the device satisfies the condition related to the computing power necessary for execution of the application.

17. A presentation controlling apparatus comprising:
a decision section configured to decide whether or not information related to computing power of a device satisfies a condition related to computing power necessary for execution of an application; and
a presentation controlling section configured to control presentation of a predetermined alert on a basis that the information related to the computing power of the device does not satisfy the condition related to the computing power necessary for execution of the application.

18. The presentation controlling apparatus according to claim 17, further comprising:
an application registration processing section configured to register the application into an information providing apparatus.

19. A presentation controlling method comprising:
deciding, by a processor, whether or not information related to computing power of a device satisfies a condition related to computing power necessary for execution of an application; and
controlling, by the processor, presentation of a predetermined alert on a basis that the information related to the computing power of the device does not satisfy the condition related to the computing power necessary for execution of the application.

20. An information processing system comprising:
an information processing apparatus; and
an information providing apparatus, wherein
the information processing apparatus includes
a device information provision section configured to provide information related to computing power of a device to the information providing apparatus, and
an application acquisition section configured to acquire an application, from the information providing apparatus, on a basis that the information related to the computing power satisfies a condition related to computing power necessary for execution of the application, and
the information providing apparatus includes
a decision section configured to decide whether or not the information related to the computing power of the device satisfies the condition related to the computing power necessary for execution of the application, and
a provision section configured to provide the application to the information processing apparatus on a basis that the information related to the computing power of the device satisfies the condition related to the computing power necessary for execution of the application.
